(19) United States
(12) Patent Application Publication
(10) Pub. No.: US 2025/0125484 A1
(43) Pub. Date: Apr. 17, 2025

(54) METHOD OF MANUFACTURING SEPARATOR, METHOD OF MANUFACTURING ELECTRODE BODY, AND METHOD OF MANUFACTURING BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/908,860

(22) Filed: Oct. 8, 2024

(30) Foreign Application Priority Data
Oct. 11, 2023 (JP) 2023-176255

(51) Int. Cl. H01M 50/403; H01M 50/46

(52) U.S. Cl. CPC H01M 50/403; H01M 50/46

(57) ABSTRACT

A method of manufacturing a separator that is disposed between a positive electrode and a negative electrode, the method including immersing a separator in a liquid that contains a surfactant; and drying the separator that has been removed from the liquid.

### CROSS-REFERENCE TO RELATED APPLICATION

This application is based on and claims priority under 35 USC 119 from Japanese Patent Application No. 2023-176255, filed on Oct. 11, 2023, the entire disclosure of which is incorporated by reference herein.

### BACKGROUND

### Technical Field

The present disclosure relates to a method of manufacturing a separator, a method of manufacturing an electrode body, and a method of manufacturing a battery.

### Related Art

In the manufacturing process of a battery using an electrolytic solution obtained by dissolving an electrolyte in an organic solvent, a liquid injection operation is performed in which an electrolytic solution is supplied to an interior of an exterior body accommodating an electrode body, and the electrolytic solution is permeated into the electrode body.

In some cases, a process is performed in which an electrode of a battery is pressed at a high pressure in order to increase an energy density. When the packing density of an electrode active material within the electrode is increased by pressing the electrode, the permeability of the electrolytic solution decreases. The decrease in the permeability of the electrolytic solution causes a decrease in the efficiency of the liquid injection operation.

Japanese Patent Application Laid-Open (JP-A) No. H9-306501 describes an organic electrolyte battery in which the impregnation time of an electrolytic solution into an electrode is shortened by manufacturing an electrode using an electrode mixture to which a surfactant having an affinity for an organic electrolytic solution is added.

The invention described in JP-A No. H9-306501 aims at improving the impregnation property of an electrolytic solution with respect to an electrode, and it is not aimed at improving the impregnation property of an electrolytic solution with respect to a separator, which is disposed between the electrodes. Further, the method of adding a surfactant to the electrode mixture may affect the performance of the electrode.

### SUMMARY

In view of the foregoing, an object of an embodiment of the present disclosure is to provide a method of manufacturing a separator that exhibits excellent permeability for an electrolytic solution, a method of manufacturing an electrode body using the separator, and a method of manufacturing a battery using the separator.

The means for solving the above-described problem includes the following embodiments.

<1> A method of manufacturing a separator that is disposed between a positive electrode and a negative electrode, the method including:
immersing a separator in a liquid that contains a surfactant; and
drying the separator that has been removed from the liquid.

<2> The method of manufacturing a separator according to <1>, including:
selecting a type of the surfactant; and
the selecting includes comparing a permeability of the separator, with respect to an electrolytic solution, before immersion in the liquid that contains the surfactant and a permeability of the separator, with respect to the electrolytic solution, after immersion in the liquid that contains the surfactant.

<3> A method of manufacturing an electrode body, the method including:
manufacturing a separator by the method according to <1> or <2>; and
disposing the separator between a positive electrode and a negative electrode.

<4> A method of manufacturing a battery, the method including:
manufacturing an electrode body by the method according to <3>; and
causing an electrolytic solution to permeate into the electrode body.

### BRIEF DESCRIPTION OF THE DRAWINGS

Exemplary embodiments of the present disclosure will be described in detail based on the following figure, wherein:

FIG. 1 is a diagram schematically illustrating an example of a configuration of a laminated body included in an electrode body;

FIG. 2 is a diagram schematically illustrating an example of application of a battery module to an electric vehicle;

FIG. 3 is a diagram schematically illustrating an example of a configuration of a battery module;

FIG. 4 is a diagram schematically illustrating an example of a configuration of a battery module; and

FIG. 5 is a diagram schematically illustrating an example of a configuration of a battery cell included in a battery module.

### DETAILED DESCRIPTION

In the present disclosure, a numerical value range expressed by using “(from) . . . to . . . ”, means a range in which the numerical values before and after the word “to” are included as the minimum value and the maximum value, respectively.

In the numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. In the numerical value ranges described in the present disclosure, the upper limit value or the lower limit value described in a given numerical range may be replaced with a value shown in the examples.

In the present disclosure, the term “step” includes not only an independent step, but also a step that cannot be clearly distinguished from another step as long as the intended purpose of the step is achieved.

In the case in which embodiments are described in the present disclosure with reference to the drawings, the configuration of an embodiment is not limited to the configuration illustrated in the drawings. Further, the sizes of the members in the drawings are conceptual, and the relative relationship between the sizes of the members is not limited thereto.

### <Method of Manufacturing Separator>

A method of manufacturing a separator of the present disclosure is a method of manufacturing a separator that is disposed between a positive electrode and a negative electrode, the method including:
immersing a separator in a liquid containing a surfactant; and
drying the separator that has been removed from the liquid.

In a general method of manufacturing a battery, an electrolytic solution obtained by dissolving an electrolyte in an organic solvent is supplied to an exterior body that accommodates an electrode body. The operation is stopped and put on hold until the electrolytic solution supplied to the exterior body permeates the electrode body. This on-hold time can cause a decrease in the efficiency of the liquid injection operation.

The electrode body that is accommodated in the exterior body includes a laminated body configured by a positive electrode, a negative electrode, and a separator that is disposed between the positive electrode and the negative electrode.

As a result of studies conducted by the present inventors, it was found that by using a separator manufactured by the above-described method, the impregnation time of the electrolytic solution into the electrode body was shortened, and the efficiency of the liquid injection operation was improved. The reason for this is considered, for example, as follows.

The electrolytic solution mainly permeates from the end surface of the electrode body, where the cross-section of the electrode is exposed. In the separator that is manufactured by the method of the present disclosure, the permeability of the electrolytic solution with respect to the separator is increased by the presence of a surfactant therein. As a result, in addition to the cross-section of the electrode exposed at the end surface of the electrode body, it is surmised that the amount of electrolytic solution that permeates from the cross-section of the separator increases, and in conjunction with this, the amount of electrolytic solution that permeates from the separator into the adjacent electrode increases.

The separator that is manufactured by the method of the present disclosure has a greater effect of shortening the impregnation time of an electrolytic solution, as compared with a separator treated with a surfactant only at a surface thereof.

The type of separator that is used in the method of the present disclosure is not particularly limited.

Specific examples of the material of the separator include polyolefins such as polyethylene and polypropylene, polyamides, polyimides, polyamideimides, and polyesters. Among these, polyolefins are preferable.

Specific examples of the form of the separator include a nonwoven fabric, a cloth, and a microporous film.

The separator may have a single-layer structure or a multilayer structure.

The thickness of the separator is not particularly limited, and may be selected from conventional thicknesses. For example, the thickness of the separator may be selected from the range of from 10 μm to 150 μm.

The type of the surfactant that is used in the method of the present disclosure is not particularly limited, and may be selected in accordance with the type of the separator and the electrolytic solution.

The selection of the surfactant to be used in the method of the present disclosure can be made, for example, by comparing the permeability of the separator, with respect to the electrolytic solution, before immersion in a liquid containing a surfactant and the permeability of the separator, with respect to the electrolytic solution, after immersion in a liquid containing a surfactant, and determining whether or not the permeability of the separator before immersion is superior to the permeability of the separator after immersion.

The electrolytic solution may be a product that is prepared for the evaluation of permeability, or may be an electrolytic solution that is actually used in a battery that includes a separator manufactured by the method of the present disclosure.

Specifically, the method of manufacturing a separator of the present disclosure may further include selecting the type of the surfactant, in which the selection of the surfactant includes comparing the permeability of the separator, with respect to the electrolytic solution, before immersion in a liquid containing the surfactant and the permeability of the separator, with respect to the electrolytic solution, after immersion in a liquid containing the surfactant.

As the liquid containing a surfactant, for example, an aqueous solution of a surfactant may be used.

The separator that has been removed from the liquid containing the surfactant may be dried using a dryer, or may be dried naturally.

### <Method of Manufacturing an Electrode Body>

The method of manufacturing an electrode body of the present disclosure includes:
manufacturing a separator by the above-described method of manufacturing a separator; and
disposing the separator between a positive electrode and a negative electrode.

In the present disclosure, an electrode body refers to a structure that includes a laminated body configured by a positive electrode, a negative electrode, and a separator that is disposed between the positive electrode and the negative electrode.

Examples of the form of the electrode body including a laminated body configured by a positive electrode, a negative electrode, and a separator that is disposed between the positive electrode and the negative electrode include a state in which plural laminated bodies, which are cut into predetermined dimensions, are layered; and a state in which an elongated laminated body is wound.

It is possible that all of the separators included in the electrode body are a separator manufactured by the above-described method, or it is possible that some of the separators contained in the electrode body are a separator manufactured by the above-described method.

The positive electrode and the negative electrode included in the electrode body each contain a positive electrode active material or a negative electrode active material as the electrode active material.

Hereinafter, the positive electrode and the negative electrode included in the electrode body may be collectively referred to as an “electrode”.

Specific examples of the positive electrode active material in a case in which the battery is a lithium-ion secondary battery include composite oxides formed of lithium and a transition metal, and optionally other metals (hereinafter, also referred to as lithium transition metal composite oxides). Examples of transition metals and other metals include Ni, Co, Mn, Al, B, Mg, Ti, V, Cr, Fe, Cu, Zn, Ga, Sr, Zr, Nb, In, Sn, Ta, W, and the like.

Examples of the lithium transition metal composite oxides include layered lithium transition metal composite oxides, spinel-type lithium transition metal composite oxides, and olivine-type lithium transition metal composite oxides.

Examples of the layered lithium transition metal composite oxides include those containing at least one selected from Ni, Co or Mn as the transition metal. Specific examples thereof include compounds represented by the structural formula of LiNiₐCo_{b}Mn_{c}O₂ (in which each of a, b, and c is a number of 0 or more and 1 or less, and a+b+c=1), and compounds in which one or more elements selected from Al, Mg, La, Ti, Zn, B, W, Fe, Cr, V, Ru, Cu, Cd, Ag, Y, Sc, Ga, In, As, Sb, Pt, Au, Si, or the like are added to the aforementioned compounds.

Specific examples of the spinel-type lithium transition metal complex oxides include LiMn₂O₄.

Specific examples of the olivine-type lithium transition metal complex oxides include LiMPO₄ (M: Fe, Co, Ni or Mn).

The positive electrode active material contained in the electrode may be a single type alone, or may be two or more types thereof.

Specific examples of the negative electrode active material in a case in which the battery is a lithium-ion secondary battery include carbon materials such as graphite, hard carbon, soft carbon, and activated carbon, silicon, metallic lithium, lithium alloys, and lithium titanate (LTO).

The negative electrode active material contained in the electrode may be a single type alone, or may be two or more types thereof.

The electrode may include a conductive material.

Specific examples of the conductive material include carbon materials such as carbon black (acetylene black, thermal black, and furnace black), carbon nanotubes, and graphite.

The conductive material contained in the electrode may be a single type alone, or may be two or more types thereof.

The electrode may include a binder.

Specific examples of the binder include polyvinylidene fluoride (PVdF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, polymethacrylate, and polytetrafluoroethylene (PTFE).

The binder contained in the electrode may be a single type alone, or may be two or more types thereof.

The electrode contained in the electrode body may include a current collector and an electrode layer that is disposed so as to contact one surface or both surfaces of the current collector.

The thickness of the electrode layer is not particularly limited, and may be selected from conventional thicknesses of electrode layers. For example, the thickness of the electrode layer may be selected from the range of from 10 μm to 200 μm.

Examples of the material that configures the current collector of the positive electrode include aluminum, aluminum alloys, nickel, titanium, and stainless steel. Examples of the shape of the current collector include a foil and a mesh.

Examples of the material that configures the current collector of the negative electrode include copper, copper alloys, nickel, titanium, and stainless steel. Examples of the shape of the current collector include a foil and a mesh.

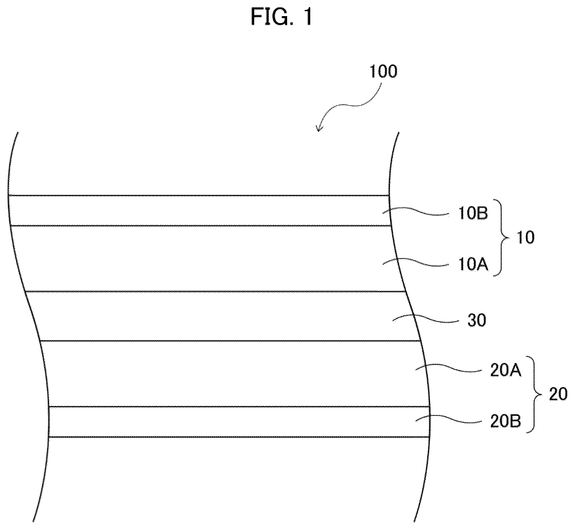

FIG. 1 schematically illustrates an example of a configuration of the laminated body included in the electrode body.

A laminated body 100 illustrated in FIG. 1 is configured by a positive electrode 10, a negative electrode 20, and a separator 30 that is disposed between the positive electrode 10 and the negative electrode 20. The positive electrode 10 is configured by a positive electrode layer 10A and a positive electrode current collector 10B. The negative electrode 20 is configured by a negative electrode layer 20A and a negative electrode current collector 20B.

### <Method of Manufacturing a Battery>

The method of manufacturing a battery of the present disclosure includes:
manufacturing an electrode body by the above-described method of manufacturing an electrode body; and
causing an electrolytic solution to permeate into the electrode body.

The method for causing the electrolytic solution to permeate into the electrode body is not particularly limited, and may be selected from known methods.

For example, the permeation of the electrolytic solution is performed by supplying the electrolytic solution to an interior of an exterior body that accommodates the electrode body.

The process of causing the electrolytic solution to permeate may include depressurizing the interior of the exterior body that accommodates the electrode body. By depressurizing the interior of the exterior body that accommodates the electrode body, it is possible to promote the permeation of the electrolytic solution into the electrode body.

The type of the exterior body in which the electrode body is accommodated is not particularly limited, and may be selected in accordance with the type of the battery.

In certain embodiments, a sheet-shaped exterior body may be used.

Examples of the sheet-shaped exterior body include those containing a metal. Specific examples include laminated bodies (so-called laminate films) having a metal layer containing a metal such as aluminum or the like, and a heat seal layer containing a resin that is melted by heating. That is to say, the battery manufactured by the method of the present disclosure may be a battery (so-called laminate battery) in which a laminate film is used as the exterior body.

The exterior body may be a single member, or may be composed of two or more members. For example, in a case in which the exterior body is a sheet-shaped object, the exterior body may be composed of one sheet-shaped object, or may be composed of two sheets-shaped objects.

If necessary, a recess for accommodating the electrode body may be formed at the sheet-shaped exterior body by embossing.

Examples of a method for accommodating the electrode body in the exterior body using a sheet-shaped exterior body include, for example, the following Method 1 and Method 2.

Method 1: a method of, in a state in which the electrode body is disposed between one exterior body that has been folded in half or between two exterior bodies that have been superposed, joining the exterior body (or bodies) at a periphery of the electrode body

Method 2: a method of inserting the electrode body into a bag that has been prepared by joining a periphery of one exterior body that has been folded in half or two exterior bodies that have been superposed

The type of the electrolytic solution to permeate into the electrode body is not particularly limited, and a substance in which a solute used in a known electrolytic solution is dissolved in a solvent may be used as the electrolytic solution.

Specific examples of the solute of the electrolytic solution include LiPF₆ and LiFSi.

The solute of the electrolytic solution may be a single type alone, or may be two or more types thereof.

Specific examples of the solvent of the electrolytic solution include cyclic or linear carbonates such as ethylene carbonate (EC), dimethyl carbonate (DMC), diethyl carbonate (DEC), and ethyl methyl carbonate (EMC). The solvent may be a mixture of two or more solvents, and may be a mixture containing a cyclic carbonate and a linear carbonate.

The solvent may contain an additive such as vinylene carbonate (VC).

### (Type of Battery and Application Examples)

The type of the battery that is manufactured by the method of the present disclosure is not particularly limited.

Specific examples of the battery include secondary batteries such as lithium-ion secondary batteries, lead storage batteries, nickel-hydrogen storage batteries, nickel-cadmium storage batteries, nickel-iron storage batteries, nickel-zinc storage batteries, silver oxide-zinc storage batteries, and cobalt-titanium-lithium secondary batteries.

From the viewpoint of energy density, versatility, and the like, the battery may be a lithium-ion secondary battery.

The battery of the present disclosure may be installed at an electric vehicle. Explanation follows of an example in which the battery of the present disclosure is applied to an electric vehicle, with reference to the drawings. In the following explanation, “battery cell 20” corresponds to the battery of the present disclosure.

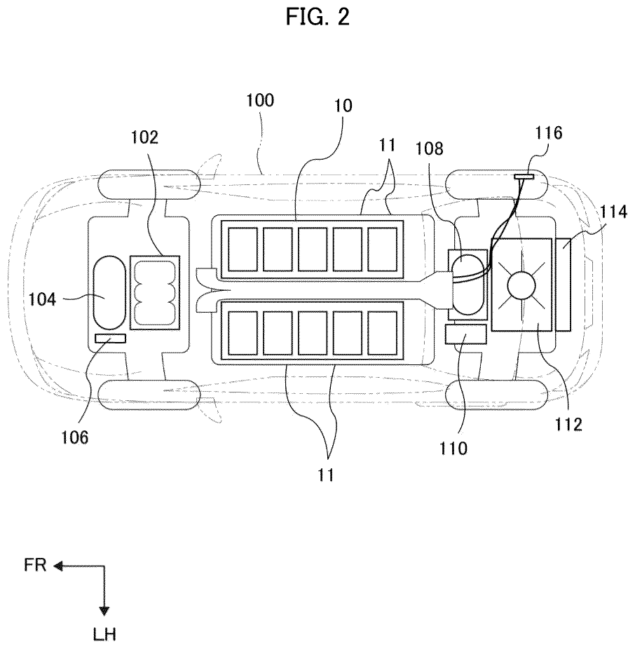

FIG. 2 is a schematic plan view illustrating a main part of a vehicle 100 to which a battery pack 10 according to an embodiment is applied. As illustrated in FIG. 2, the vehicle 100 is an electric vehicle (battery electric vehicle (BEV)) to which the battery pack 10 is installed under a floor. It should be noted that in each of the drawings, the arrow UP, the arrow FR, and the arrow LH respectively indicate an upper side in a vehicle up-down direction, a front side in a vehicle front-rear direction, and a left side in a vehicle width direction. Unless specifically stated otherwise, in a case in which front-rear, left-right, and up-down directions are described, these refer to the front and rear in the vehicle front-rear direction, the left and right in the vehicle width direction, and up and down in a vehicle up-down direction.

As an example, in the vehicle 100 of the present embodiment, a DC/DC converter 102, an electric compressor 104, and a positive temperature coefficient (PTC) heater 106 are disposed further to a vehicle front side than the battery pack 10. Further, a motor 108, a gear box 110, an inverter 112, and a charger 114 are disposed further to a vehicle rear side than the battery pack 10.

A DC current that has been output from the battery pack 10 is adjusted in voltage by the DC/DC converter 102, and then is supplied to the electric compressor 104, the PTC heater 106, the inverter 112, and the like. Further, by electric power being supplied to the motor 108 via the inverter 112, the rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the above-described configuration. For example, the present disclosure may be applied to vehicles installed with an engine such as hybrid vehicles (HV) and plug-in hybrid electric vehicles (PHEV). Further, in the present embodiment, although the vehicle is configured as a rear-wheel-drive vehicle in which the motor 108 is installed at a rear portion of the vehicle, there is no limitation thereto; the vehicle may be configured as a front-wheel-drive vehicle in which the motor 108 is installed at a front portion of the vehicle, and a pair of motors 108 may also be installed at the front and rear of the vehicle. Furthermore, the vehicle may also be provided with in-wheel motors at the respective wheels.

The battery pack 10 includes plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Further, each of the battery modules 11 is electrically connected to each other.

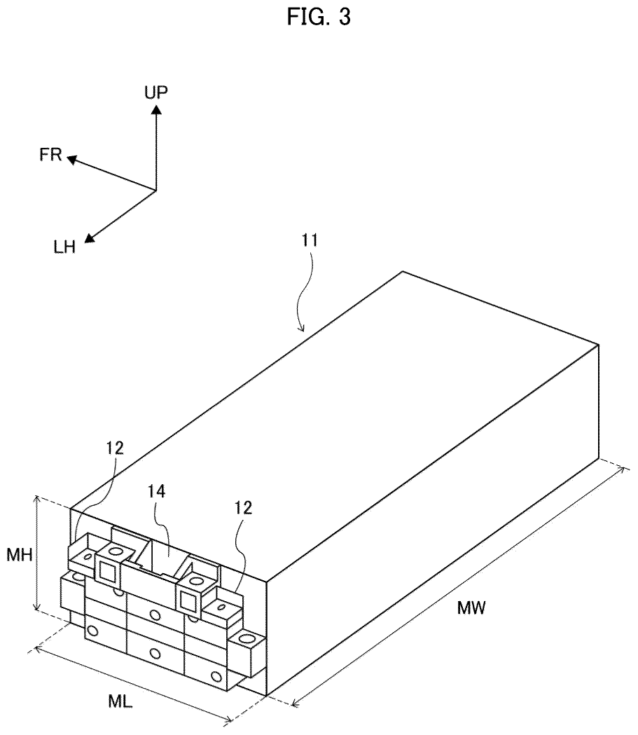

FIG. 3 is a schematic perspective view of the battery module 11. As illustrated in FIG. 2, the battery module 11 is formed in a substantially rectangular parallelepiped shape having a longitudinal direction along the vehicle width direction. Further, an outer shell of the battery module 11 is formed of an aluminum alloy. For example, the outer shell of the battery module 11 is formed by joining aluminum die-casting to both end portions of an extruded material of an aluminum alloy by laser welding or the like.

A pair of voltage terminals 12 and a connector 14 are provided at both vehicle width direction end portions of the battery module 11. A flexible printed circuit board 21, which is described below, is connected to the connector 14. Furthermore, bus bars, which are not illustrated in the drawings, are welded to both vehicle width direction end portions of the battery module 11.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

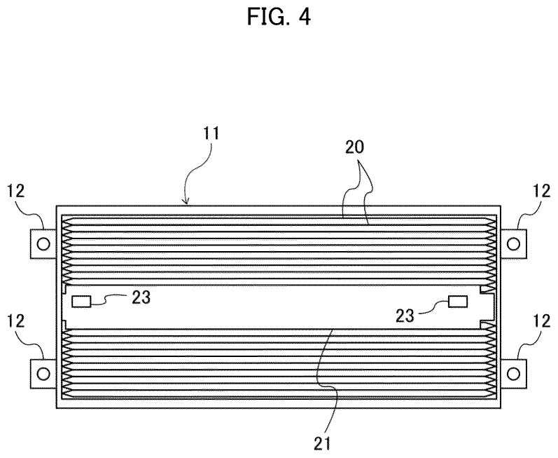

FIG. 4 is a plan view of the battery module 11 in a state in which an upper lid thereof has been removed. As illustrated in FIG. 4, plural battery cells 20 are accommodated at the interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured so to be pressed toward a battery cells 20 side by the upper lid of the battery module 11.

Further, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are disposed at both end portions in the longitudinal direction of battery module 11 and at the center portion in the longitudinal direction of the battery module 11, respectively.

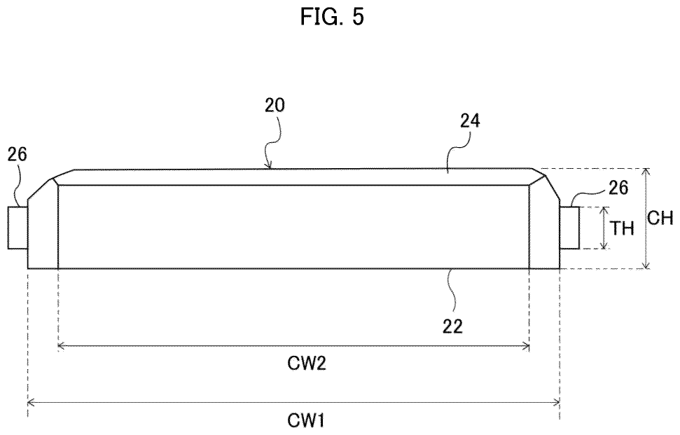

FIG. 5 is a schematic diagram in which a battery cell 20 that is accommodated in the battery module 11 is viewed from the thickness direction thereof. As illustrated in FIG. 5, the battery cell 20 is formed in a substantially rectangular plate shape, and an electrode body, which is not illustrated in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method of manufacturing a separator that is disposed between a positive electrode and a negative electrode, the method comprising:
immersing a separator in a liquid that contains a surfactant; and
drying the separator that has been removed from the liquid.

2. The method of manufacturing a separator according to claim 1, comprising:
selecting a type of the surfactant; and
the selecting includes comparing a permeability of the separator, with respect to an electrolytic solution, before immersion in the liquid that contains the surfactant and a permeability of the separator, with respect to the electrolytic solution, after immersion in the liquid that contains the surfactant.

3. A method of manufacturing an electrode body, the method comprising:
manufacturing a separator by the method according to claim 1; and
disposing the separator between a positive electrode and a negative electrode.

4. A method of manufacturing a battery, the method comprising:
manufacturing an electrode body by the method according to claim 3; and
causing an electrolytic solution to permeate into the electrode body.
